(19) United States
(12) Patent Application Publication
(10) Pub. No.: US 2026/0367547 A1
(43) Pub. Date: Nov. 19, 2026

(54) ENDLESS BELT, INTERMEDIATE TRANSFER BELT, TRANSFER DEVICE, AND IMAGE FORMING APPARATUS

(71) Applicant: FUJIFILM Business Innovation Corp., Tokyo (JP)

(72) Inventors: Masato FURUKAWA, Kanagawa (JP); Hiroaki TANAKA, Kanagawa (JP); Kenji KAJIWARA, Kanagawa (JP); Yuki MITANI, Kanagawa (JP); Tomotake INAGAKI, Kanagawa (JP)

(73) Assignee: FUJIFILM Business Innovation Corp., Tokyo (JP)

(21) Appl. No.: 19/465,224

(22) Filed: Jan. 30, 2026

(30) Foreign Application Priority Data
May 15, 2025 (JP) 2025-082085

(51) Int. Cl. G03G 15/16

(52) U.S. Cl. CPC G03G 15/162

(57) ABSTRACT

An endless belt contains: a resin; and conductive particles, in which, in a case where a cross section along a belt thickness direction is observed, in Voronoi division using centroids of the conductive particles as seed points, an average value of areas of Voronoi polygons is 1400 nm² or more and 2000 nm² or less, and a standard deviation of the areas of the Voronoi polygons is 1200 nm² or less, an average dispersion size of the conductive particles is 30 nm or less, and an average value of a nearest-neighbor distance distribution of the conductive particles is 20 nm or more and 40 nm or less.

### CROSS-REFERENCE TO RELATED APPLICATIONS

This application is based on and claims priority under 35 USC 119 from Japanese Patent Application No. 2025-082085 filed May 15, 2025.

### BACKGROUND

### (i) Technical Field

The present invention relates to an endless belt, an intermediate transfer belt, a transfer device, and an image forming apparatus.

### (ii) Related Art

In an image forming apparatus (such as a copy machine, a facsimile machine, or a printer) using an electrophotographic method, a toner image formed on the surface of an image holder is transferred onto a surface of a recording medium and fixed onto the recording medium such that an image is formed. For the transfer of the toner image onto the recording medium, for example, an intermediate transfer belt is used. Various endless belts, such as a transport belt, are used not only in the image forming apparatus, but also in other apparatuses.

For example, JP2023-135214A discloses “an endless belt in which a ratio (area B/area A) of a graph area B of a region having a particle diameter exceeding 35 nm to a graph area A of a region having a particle diameter of 35 nm or less in a volume frequency distribution of particles determined by small-angle X-ray scattering measurement is 0.3 or less”.

JP2021-092598A discloses “an endless belt in which, in a spatial distribution of first conductive carbon particles present in an evaluation region of 6.3 μm×4.2 μm on an outer peripheral surface, an integral value of a statistic L(r) at an interparticle distance r of 0.05 μm or more and 0.30 μm or less is 0 or more and 0.1 or less”.

JP2023-008686A discloses “an electrophotographic belt in which, in a case where a cross section in a direction orthogonal to a circumferential direction of the electrophotographic belt is subjected to Voronoi division with particles of magnesium hydroxide exposed on the cross section as seed points, assuming that an arithmetic average value of areas of Voronoi polygons formed by the division is S and a standard deviation is a, a coefficient of variation (=a/S) is 1.5 or less”.

### SUMMARY

Aspects of non-limiting embodiments of the present disclosure relate to an endless belt having excellent breakage resistance and excellent dispersibility of conductive particles in a belt thickness direction as compared with an endless belt in which, in a case where a cross section of an endless belt containing a resin and conductive particles along the belt thickness direction is observed, in Voronoi division using centroids of the conductive particles as seed points, an average value of areas of Voronoi polygons is less than 1400 nm² or more than 2000 nm², a standard deviation of the areas of the Voronoi polygons is more than 1200 nm², an average dispersion size of the conductive particles is more than 30 nm, or an average value of a nearest-neighbor distance distribution of the conductive particles is less than 20 nm or more than 40 nm.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

Means for achieving the above object include the following aspects.

An endless belt containing:
a resin; and
conductive particles,
in which, in a case where a cross section along a belt thickness direction is observed,
   in Voronoi division using centroids of the conductive particles as seed points, an average value of areas of Voronoi polygons is 1400 nm² or more and 2000 nm² or less, and a standard deviation of the areas of the Voronoi polygons is 1200 nm² or less,
   an average dispersion size of the conductive particles is 30 nm or less, and
   an average value of a nearest-neighbor distance distribution of the conductive particles is 20 nm or more and 40 nm or less.

### BRIEF DESCRIPTION OF THE DRAWINGS

Exemplary embodiment(s) of the present invention will be described in detail based on the following figures, wherein:

FIG. 1 is a schematic configuration diagram showing an example of an image forming apparatus according to the present exemplary embodiment; and

FIG. 2 is a schematic configuration diagram showing the periphery of a secondary transfer portion in another example of the image forming apparatus according to the present exemplary embodiment.

### DETAILED DESCRIPTION

Hereinafter, the present exemplary embodiment as an example of the present invention will be described. The following descriptions and Examples merely illustrate the exemplary embodiments, and do not limit the scope of the exemplary embodiments.

Regarding the numerical ranges described in stages in the present exemplary embodiment, the upper limit value or lower limit value of a numerical range may be replaced with the upper limit value or lower limit value of another numerical range described in stages. In addition, in the present exemplary embodiment, the upper limit value or lower limit value of a numerical range may be replaced with values described in Examples.

In the present exemplary embodiment, the term “step” includes not only an independent step but also a step that cannot be clearly distinguished from other steps but can achieve the expected object thereof.

In the present exemplary embodiment, in a case where an exemplary embodiment is described with reference to drawings, the configuration of the exemplary embodiment is not limited to the configuration shown in the drawings. In addition, the sizes of members in each drawing are conceptual and do not limit the relative relationship between the sizes of the members.

In the present exemplary embodiment, each component may include a plurality of corresponding substances. In the present exemplary embodiment, in a case where the amount of each component in a composition is mentioned, and there are two or more kinds of substances corresponding to each component in the composition, unless otherwise specified, the amount of each component means the total amount of two or more kinds of the substances present in the composition.

### Endless Belt

An endless belt according to the present exemplary embodiment contains a resin and conductive particles.

In a case where a cross section along a belt thickness direction is observed, in Voronoi division using centroids of the conductive particles as seed points, an average value of areas of Voronoi polygons is 1400 nm² or more and 2000 nm² or less, a standard deviation of the areas of the Voronoi polygons is 1200 nm² or less, an average dispersion size of the conductive particles is 30 nm or less, and an average value of a nearest-neighbor distance distribution of the conductive particles is 20 nm or more and 40 nm or less.

In the related art, in the endless belt, the conductive particles have a function of imparting conductivity to the belt, but are one of causes of a decrease in breakage resistance.

Therefore, a technique of improving the dispersibility of the conductive particles is known (JP2023-135214A, JP2021-092598A, JP2023-008686A, and the like).

However, in response to the recent demand for improved performance, further improvement is needed.

Therefore, in the endless belt according to the present exemplary embodiment, in a case where the cross section along the belt thickness direction is observed, the average value of the areas of the Voronoi polygons, the standard deviation of the areas of the Voronoi polygons, the average dispersion size of the conductive particles, and the average value of the nearest-neighbor distance distribution of the conductive particles are controlled within the above-described ranges. This improves the dispersibility of the conductive particles not only in the belt surface direction but also in the belt thickness direction. In addition, the conductive particles are prevented from being a starting point of breakage.

As described above, the endless belt according to the present exemplary embodiment has the above-described configuration, and is an endless belt having excellent breakage resistance and excellent dispersibility of the conductive particles in the belt thickness direction.

The endless belt according to the present exemplary embodiment has the above-described characteristics, and therefore has increased electrical resistance in a case where a high voltage is applied, and is improved in maintaining electrical conductivity. Therefore, in a case where the endless belt according to the present exemplary embodiment is applied to a transfer belt (particularly, an intermediate transfer belt), the endless belt has excellent breakage resistance and transfer retention.

Hereinafter, details of the endless belt according to the present exemplary embodiment will be described.

### Area of Voronoi Polygon

In the endless belt according to the present exemplary embodiment, the average value of the areas of the Voronoi polygons in the Voronoi division using the centroids of the conductive particles as seed points is 1400 nm² or more and 2000 nm² or less, for example, preferably 1500 nm² or more and 1900 nm² or less, and more preferably 1600 nm² or more and 1800 nm² or less.

In a case where the average value of the areas of the Voronoi polygons is less than 1400 nm², a decrease in breakage resistance occurs, and the dispersibility of the conductive particles in the belt thickness direction deteriorates.

In a case where the average value of the areas of the Voronoi polygons is more than 2000 nm², the dispersibility of the conductive particles in the belt thickness direction deteriorates, which causes non-uniformity of conductivity.

Therefore, by setting the average value of the areas of the Voronoi polygons within the above-described range, the breakage resistance as well as the dispersibility of the conductive particles in the belt thickness direction are improved.

The standard deviation of the areas of the Voronoi polygons is 1200 nm² or less, for example, preferably 1000 nm² or less and more preferably 900 nm² or less.

In a case where the standard deviation of the areas of the Voronoi polygons is more than 1200 nm², a decrease in breakage resistance occurs, and the dispersibility of the conductive particles in the belt thickness direction deteriorates.

The average value of the areas of the Voronoi polygons and the standard deviation of the areas of the Voronoi polygons are measured as follows.

A sample is taken from a target endless belt, with a cross section cut along a belt thickness direction as an observation surface.

The cross section of the sample is observed with a scanning transmission electron microscope (STEM), and a STEM image is recorded at a magnification of 100,000 at which the entire cross section in the belt thickness direction is observed. For the recorded STEM image, image analysis is performed using image analysis software (ImageJ: manufactured by National Institutes of Health) under a condition of 0.010 μm/pixel.

Voronoi polygon division (drawing a perpendicular bisector to a straight line connecting adjacent seed points and dividing a nearest-neighbor region of each seed point) is performed using centroids of all conductive particles present in the STEM image as seed points, and areas of all formed Voronoi polygons are measured.

Here, the centroids of the conductive particles indicate centroids of primary particles of the conductive particles in a case where the conductive particles are present as primary particles, and indicates centroids of secondary particles of the conductive particles in a case where the conductive particles are present as secondary particles.

The centroids of the primary particles and secondary particles of the conductive particles are defined as follows: in a case where the number of pixels in the region of the primary particles and the secondary particles is denoted by n, and x and y coordinates of each pixel are denoted by xᵢ and yᵢ (i=1, 2, . . . , n), the x coordinate of the centroid=(total of xᵢ)/n and the y coordinate of the centroid=(total of yᵢ)/n.

The procedure for measuring the area of the Voronoi polygon using the image processing software (ImageJ: manufactured by National Institutes of Health) is as follows.
1. In Analyze→Set Scale, a relationship between the number of pixels on the image and the actual distance is defined. For example, in a case where 144 pixels correspond to 1.5 μm, “Distance in Pixels: 144” and “Known distance: 1.5” are input, and a check box of “Global” is checked.
2. Image→Type→8-bit is selected.
3. Image→Adjust→Threshold is selected, “Dark background” is checked, and an Auto button is clicked.
4. Process→Noise→Despeckle is processed to remove speckle image noise.
5. Process→Binary→Watershed is processed to divide the conductive particles that appear overlapped by highlighting the contours of the conductive particles.
6. Process→Binary→Voronoi is processed to create a Voronoi polygon with the “centroids” of the conductive particles as seed points.
7. Line segments that are derived from the outermost conductive particles and do not form a Voronoi polygon are deleted.
8. Image→Type→8-bit is selected.
9. Image→Adjust→Threshold is processed to color the sides of the Voronoi polygon in red.
10. Edit→Invert is processed to invert white and black so as to color the sides of the Voronoi polygon in white.
11. Analyze→Analyze Particle (size: 0-Infinity, Circularity: 0.00-1.00, Show: Outlines) is processed to obtain the area of the Voronoi polygon.

The above operation is carried out five times, and an arithmetic average value of the areas of the Voronoi polygons obtained and a standard deviation of the areas of the Voronoi polygons are calculated.

### Average Dispersion Size of Conductive Particles

The average dispersion size of the conductive particles is 30 nm or less, for example, more preferably 27 nm or less.

In a case where the average dispersion size of the conductive particles is more than 30 nm, the breakage resistance as well as the dispersibility of the conductive particles in the belt thickness direction decrease.

The lower limit of the average dispersion size of the conductive particles is not particularly limited, but the average dispersion size of the conductive particles is preferably 10 nm or more and more preferably 13 nm or more.

The average dispersion size of the conductive particles is measured as follows.

A sample is taken from a target endless belt, with a cross section cut along a belt thickness direction as an observation surface.

The cross section of the sample is observed with a scanning transmission electron microscope (STEM), and a STEM image is recorded at a magnification of 100,000 at which the entire cross section in the belt thickness direction is observed. For the recorded STEM image, image analysis is performed using image analysis software (ImageJ: manufactured by National Institutes of Health) under a condition of 0.010 μm/pixel.

A circle-equivalent diameter of the conductive particles observed in the STEM image is determined and is taken as a dispersion size of the conductive particles. Here, the dispersion size of the conductive particles indicates a dispersion size of primary particles of the conductive particles in a case where the conductive particles are present as primary particles, and indicates a dispersion size of secondary particles of the conductive particles in a case where the conductive particles are present as secondary particles.

The above operation is carried out five times, and an arithmetic average value of the dispersion sizes obtained is calculated.

### Average Value of Nearest-Neighbor Distance Distribution of Conductive Particles

The average value of the nearest-neighbor distance distribution of the conductive particles is 20 nm or more and 40 nm or less, for example, preferably 30 nm or more and 35 nm or less, and more preferably 30 nm or more and 33 nm or less.

In a case where the average value of the nearest-neighbor distance distribution of the conductive particles is less than 20 nm or more than 40 nm, the breakage resistance as well as the dispersibility of the conductive particles in the belt thickness direction decrease.

The average value of the nearest-neighbor distance distribution of the conductive particles is measured as follows.

A sample is taken from a target endless belt, with a cross section cut along a belt thickness direction as an observation surface.

The cross section of the sample is observed with a scanning transmission electron microscope (STEM), and a STEM image is recorded at a magnification of 100,000 at which the entire cross section in the belt thickness direction is observed. For the recorded STEM image, image analysis is performed using image analysis software (ImageJ: manufactured by National Institutes of Health) under a condition of 0.010 μm/pixel.

A distance between adjacent seed points is measured using the centroids of all conductive particles present in the STEM image as seed points, and the shortest distance becomes the nearest-neighbor distance. This operation is carried out on all particles in the image, and a distribution of the nearest-neighbor distances is calculated. An arithmetic average value of the obtained distribution of the nearest-neighbor distances is obtained, and the obtained value becomes the average value of the nearest-neighbor distance distribution.

### Composition

The endless belt according to the present exemplary embodiment contains a resin and conductive particles. Specifically, for example, the endless belt is made of a single layer of a resin layer containing conductive particles. In addition, the endless belt (the resin layer constituting the endless belt) may contain silicone oil and other known components as necessary.

Here, in order to set the average value of the areas of the Voronoi polygons, the standard deviation of the areas of the Voronoi polygons, the average dispersion size of the conductive particles, and the average value of the nearest-neighbor distance distribution of the conductive particles within the above-described ranges, for example, it is preferable to apply a polyimide resin (particularly, an imidized product of a polyamic acid having amino groups at all terminals) as the resin, and to apply carbon black (particularly, carbon black having an amount of surface functional groups within a specific range, as determined by back titration with NaHCO₃) as the conductive particles.

### Resin

Examples of the resin include a polyimide resin (PI resin), a polyamide-imide resin (PAI resin), an aromatic polyether ketone resin (for example, an aromatic polyether ether ketone resin), a polyphenylene sulfide resin (PPS resin), and a polyetherimide resin (PEI resin), a polyester resin, a polyamide resin, and a polycarbonate resin.

From the viewpoint of improving bending resistance during rotational driving, the resin is, for example, preferably a polyimide-based resin (that is, a resin containing a constitutional unit having an imide bond), more preferably a polyimide resin or a polyamide-imide resin, and still more preferably a polyimide resin.

Examples of the polyimide resin include an imidization product of polyamic acid (polyimide resin precursor) which is a polymer of a tetracarboxylic dianhydride and a diamine compound.

Examples of the polyimide resin include a resin having a constitutional unit represented by General Formula (I).

[symbol]

In General Formula (I), R¹ represents a tetravalent organic group, and R² represents a divalent organic group.

Examples of the tetravalent organic group represented by R¹ include an aromatic group, an aliphatic group, a cyclic aliphatic group, a group obtained by combining an aromatic group and an aliphatic group, and a group obtained by the substitution of these groups. Specific examples of the tetravalent organic group include a residue of a tetracarboxylic dianhydride which will be described below.

Examples of the divalent organic group represented by R² include an aromatic group, an aliphatic group, a cyclic aliphatic group, a group obtained by combining an aromatic group and an aliphatic group, and a group obtained by the substitution of these groups. Specific examples of the divalent organic group include a residue of a diamine compound which will be described below.

Specifically, examples of the tetracarboxylic dianhydride used as a raw material of the polyimide resin include pyromellitic dianhydride, 3,3′,4,4′-benzophenone tetracarboxylic dianhydride, 3,3′,4,4′-biphenyltetracarboxylic dianhydride, 2,3,3′,4-biphenyltetracarboxylic dianhydride, 2,3,6,7-naphthalenetetracarboxylic dianhydride, 1,2,5,6-naphthalenetetracarboxylic dianhydride, 1,4,5,8-naphthalenetetracarboxylic dianhydride, 2,2′-bis(3,4-dicarboxyphenyl)sulfonic dianhydride, perylene-3,4,9,10-tetracarboxylic dianhydride, bis(3,4-dicarboxyphenyl)ether dianhydride, and ethylenetetracarboxylic dianhydride.

Specific examples of the diamine compound used as a raw material of the polyimide resin include 4,4′-diaminodiphenyl ether, 4,4′-diaminodiphenylmethane, 3,3′-diaminodiphenylmethane, 3,3′-dichlorobenzidine, 4,4′-diaminodiphenylsulfide, 3,3′-diaminodiphenylsulfone, 1,5-diaminonaphthalene, m-phenylenediamine, p-phenylenediamine, 3,3′-dimethyl 4,4′-biphenyldiamine, benzidine, 3,3′-dimethylbenzidine, 3,3′-dimethoxybenzidine, 4,4′-diaminodiphenylsulfone, 4,4′-diaminodiphenylpropane, 2,4-bis(β-amino tert-butyl)toluene, bis(p-β-amino-tert-butylphenyl)ether, bis(p-β-methyl-δ-aminophenyl)benzene, bis-p-(1,1-dimethyl-5-amino-pentyl) benzene, 1-isopropyl-2,4-m-phenylenediamine, m-xylylene diamine, p-xylylene diamine, di(p-aminocyclohexyl)methane, hexamethylenediamine, heptamethylenediamine, octamethylenediamine, nonamethylenediamine, decamethylenediamine, diaminopropyltetradiamine, 3-methylheptamethylenediamine, 4,4-dimethylheptamethylenediamine, 2,11-diaminododecane, 1,2-bis-3-aminopropoxyethane, 2,2-dimethylpropylenediamine, 3-methoxyhexamethylenediamine, 2,5-dimethylheptamethylenediamine, 5-methylnonamethylenediamine, 2,17-diaminoeicosadecane, 1,4-diaminocyclohexane, 1,10-diamino-1,10-dimethyldecane, 12-diaminooctadecane, 2,2-bis[4-(4-aminophenoxy)phenyl]propane, piperazine, H₂N(CH₂)₃O(CH₂)₂O(CH₂)NH₂, H₂N(CH₂)₃S(CH₂)₃NH₂, and H₂N(CH₂)₃N(CH₃)₂(CH₂)₃NH₂.

Examples of the polyamide-imide resin include a resin having an imide bond and an amide bond in a repeating unit.

More specifically, examples of the polyamide-imide resin include a polymer of a trivalent carboxylic acid compound (also called a tricarboxylic acid) having an acid anhydride group and a diisocyanate compound or a diamine compound.

As the tricarboxylic acid, for example, a trimellitic acid anhydride and a derivative thereof are preferable. In addition to the tricarboxylic acid, a tetracarboxylic dianhydride, an aliphatic dicarboxylic acid, an aromatic dicarboxylic acid, or the like may also be used.

Examples of the diisocyanate compound include 3,3′-dimethylbiphenyl-4,4′-diisocyanate, 2,2′-dimethylbiphenyl-4,4′-diisocyanate, biphenyl-4,4′-diisocyanate, biphenyl-3,3′-diisocyanate, biphenyl-3,4′-diisocyanate, 3,3′-diethylbiphenyl-4,4′-diisocyanate, 2,2′-diethylbiphenyl-4,4′-diisocyanate, 3,3′-dimethoxybiphenyl-4,4′-diisocyanate, 2,2′-dimethoxybiphenyl-4,4′-diisocyanate, naphthalene-1,5-diisocyanate, and naphthalene-2,6-diisocyanate.

Examples of the diamine compound include a compound that has the same structure as the aforementioned isocyanate and has an amino group instead of an isocyanato group.

As the polyimide resin, particularly, for example, an imidized product of a polyamic acid having amino groups at all terminals (that is, an imidized product of a polyamic acid having amino groups at both terminals of a molecular chain) is preferable. In a case where an imidized product of a polyamic acid having amino groups at all terminals is applied, the dispersibility of the conductive particles (particularly, carbon black has an amount of surface functional groups, as determined by back titration with NaHCO₃, of 0.3 mmol/g or more and 0.6 mmol/g or less) is likely to be increased. As a result, it becomes easy to control the average value of the areas of the Voronoi polygons, the average dispersion size of the conductive particles, and the average value of the nearest-neighbor distance distribution of the conductive particles within the above-described ranges.

Here, the polyamic acid having amino groups at all terminals is a polyamic acid in which a proportion Y/X of a total molar amount (Y) of terminal carboxy groups to a total molar amount (X) of terminal amino groups is 0 (that is, Y=0).

The total molar amount (X) of the terminal amino groups is measured by neutralization titration of a polyamic acid composition with an acid (for example, hydrochloric acid). On the other hand, the total molar amount (Y) of the terminal carboxy groups is measured by neutralization titration of a polyamic acid composition with a base (for example, sodium hydroxide).

The polyamic acid having amino groups at all terminals can be synthesized by using a large amount of the diamine compound in a reaction between the tetracarboxylic dianhydride and the diamine compound.

The resin content of the endless belt (the resin layer constituting the endless belt) is, for example, preferably 60% by mass or more and 95% by mass or less, more preferably 70% by mass or more and 95% by mass or less, and still more preferably 75% by mass or more and 90% by mass or less.

### Conductive Particles

Examples of the conductive particles include conductive powders (for example, powders having a volume resistivity of less than 10⁷ Ω·cm, the same applies hereinafter) and semi-conductive powders (for example, powders having a volume resistivity of 10⁷ Ω·cm or more and 10¹³ Ω·cm or less, the same applies hereinafter).

Specifically, examples of the conductive particles include conductive carbon particles and metal oxide particles.

Examples of the conductive carbon particles include carbon black.

Examples of the carbon black include Ketjen black, oil furnace black, channel black, and acetylene black. As the carbon black, carbon black having undergone a surface treatment (hereinafter, also called “surface-treated carbon black”) may be used.

The surface-treated carbon black is obtained by adding, for example, a carboxy group, a quinone group, a lactone group, a hydroxy group, or the like to the surface of carbon black. Examples of the surface treatment method include an air oxidation method of reacting carbon black by bringing the carbon black into contact with air in a high temperature atmosphere, a method of reacting carbon black with nitrogen oxide or ozone at room temperature (for example, 22 °C), and a method of oxidizing carbon black with air in a high temperature atmosphere and then with ozone at a low temperature.

Examples of the metal oxide particles include tin oxide particles, titanium oxide particles, zinc oxide particles, and zirconium oxide particles.

Examples of the conductive particles include metal particles (for example, aluminum particles, and nickel particles), and ionic conductive particles (for example, potassium titanate particles, and LiCl particles).

Among these, the conductive particles are, for example, preferably carbon black.

In addition, as the carbon black, particularly, for example, carbon black having an amount of surface functional groups, as determined by back titration with NaHCO₃, of 0.3 mmol/g or more and 0.6 mmol/g or less (for example, preferably 0.4 mmol/g or more and 0.5 mmol/g or less) is preferable.

Here, the carbon black having an amount of surface functional groups within the above-described range, as determined by back titration with NaHCO₃, corresponds to carbon black with a reduced amount of carboxyl groups.

In a case where the carbon black (particularly, carbon black has an amount of surface functional groups, as determined by back titration with NaHCO₃, of 0.3 mmol/g or more and 0.6 mmol/g or less) is applied, the dispersibility of the carbon black in the polyimide resin (particularly, an imidized product of a polyamic acid having amino groups at all terminals) is improved. As a result, it becomes easy to control the average value of the areas of the Voronoi polygons, the standard deviation of the areas of the Voronoi polygons, the average dispersion size of the conductive particles, and the average value of the nearest-neighbor distance distribution of the conductive particles within the above-described ranges.

Examples of methods of controlling the amount of surface functional groups in the carbon black, as determined by back titration with NaHCO₃, within the above-described range include liquid-phase oxidation treatment using nitric acid (HNO₃) sulfuric acid (H₂SO₄), or the like, gas-phase oxidation treatment using nitrogen monoxide (NOₓ) or ozone (O₃), oxygen plasma treatment, and thermal oxidation treatment.

The method of measuring the amount of surface functional groups in the carbon black, as determined by back titration with NaHCO₃, is as follows.

First, the carbon black is dried at 100 °C to remove moisture, and then 100 mg thereof is weighed to obtain a sample.

To the obtained sample, 3 mL of a 0.1 mol/L aqueous solution of NaHCO₃ and 40 mL of pure water are added, the mixture is subjected to ultrasonic dispersion for 5 minutes and stirring for 1 hour, and then is filtered through a syringe filter with a diameter of 0.45 μm to prepare a titration-adjusted solution using 20 mL of a supernatant.

The adjusted solution is titrated using a 0.1 mol/L aqueous hydrochloric acid solution, and the titration amount is determined from an inflection point. The amount of surface functional groups of the carbon black is calculated by the following equation, taking the amount of consumed base reagent as a comparison with a blank solution (total amount: 43 mL) without carbon black.

Calculation equation:Amount×of surface acidic groups per 1 g={(0.1×α)−(0.1×β×43÷20)}×1000÷d
α: equivalence-point titrant addition amount of blank solution (L),
β: equivalence-point titrant addition amount of sample solution (L), and
d: weighed amount of carbon black (mg).

An average primary particle size of the conductive particles is, for example, preferably 2 nm or more and 40 nm or less, more preferably 8 nm or more and 20 nm or less, and still more preferably 10 nm or more and 15 nm or less.

The average primary particle size of the conductive particles is obtained by measuring only the circle-equivalent diameter of the primary particles of the conductive particles in the method of measuring the average dispersion size of the conductive particles, and calculating an arithmetic average value of the obtained primary particles.

The content of the conductive particles (particularly, carbon black) is, for example, preferably 16 parts by mass or more and 26 parts by mass or less, more preferably 18 parts by mass or more and 24 parts by mass or less, and still more preferably 20 parts by mass or more and 23 parts by mass or less with respect to 100 parts by mass of the resin.

In a case where the content of the conductive particles (particularly, carbon black) is 16 parts by mass or more, it becomes easy to control the average value of the areas of the Voronoi polygons, the standard deviation of the areas, the average dispersion size of the conductive particles, and the average value of the nearest-neighbor distance distribution of the conductive particles within the above-described ranges.

In a case where the content of the conductive particles (particularly, carbon black) is 26 parts by mass or less, it becomes easy to suppress a decrease in breakage resistance.

### Silicone Oil

The silicone oil has a function of improving the cleaning performance of the endless belt.

Examples of the silicone oil include straight silicone oil such as dimethyl silicone oil, methyl hydrogen silicone oil, diphenyl silicone oil, methylphenyl silicone oil, and chlorophenyl silicone oil; and modified silicone oil such as alkyl-modified silicone oil, aralkyl-modified silicone oil, polyether-modified silicone oil, polyester-modified silicone oil, fluoroalkyl-modified silicone oil, amino-modified silicone oil, alkoxy-modified silicone oil, epoxy-modified silicone oil, and carboxyl-modified silicone oil.

Among these, from the viewpoint of improving the cleaning performance, as the silicone oil, for example, at least one silicone oil selected from the group consisting of dimethyl silicone oil and modified silicone oil is preferable.

The modified silicone oil is dimethyl silicone oil in which a part of methyl groups of the dimethyl silicone oil is replaced with an organic functional group, and examples thereof include the above-described various modified silicone oils. Among these, for example, aralkyl-modified silicone oil or polyether-modified silicone oil is preferable, and aralkyl-modified silicone oil is more preferable.

### Other Components

Examples of other components include a filler for improving mechanical strength, an antioxidant for preventing thermal deterioration of a belt, a surfactant for improving fluidity, and a heat-resistant antioxidant.

In a case where the other components are contained, the content of the other components is, for example, preferably more than 0% by mass and 10% by mass or less, more preferably more than 0% by mass and 5% by mass or less, and still more preferably more than 0% by mass and 1% by mass or less with respect to the endless belt (the resin layer constituting the endless belt).

### Thickness of Endless Belt

A thickness of the endless belt (the resin layer constituting the endless belt) according to the present exemplary embodiment is, for example, preferably 60 μm or more and 120 μm or less, and more preferably 60 μm or more and 110 μm or less.

The thickness of the endless belt is measured as follows.

That is, a cross section of the endless belt taken along the thickness direction is observed with an optical microscope or a scanning electron microscope, the thickness of the endless belt to be measured is measured at 10 sites, and an average value thereof is defined as the thickness.

### Young's Modulus

From the viewpoint of improving breakage resistance, a Young's modulus of the endless belt according to the present exemplary embodiment is, for example, preferably 2900 MPa or more and 5500 MPa or less, and more preferably 3000 MPa or more and 3600 MPa or less.

The Young's modulus of the endless belt is adjusted, for example, by a type of the resin and a weight-average molecular weight of the resin.

The method of measuring the Young's modulus of the endless belt is as follows.

Using a tensile tester (MODEL-1605N, manufactured by Aikoh Engineering Co., Ltd.), the endless belt is cut into an 80 mm×5 mm test piece such that a circumferential direction of the endless belt becomes a long side, and the test is carried out at a tensile speed of 20 mm/min with the test piece length between chuck jigs set to 40 mm. The Young's modulus is calculated from a slope of a region (where strain ranges from 10 N to 38 N) in which an S-S curve is linear.

### Method of Manufacturing Endless Belt

The method of manufacturing the endless belt according to the present exemplary embodiment includes, for example,
a step of applying a resin solution containing a resin or a resin precursor and conductive particles onto a surface of a mold to form a coating film,
a step of heating and drying the coating film and, as necessary, reacting the precursor (for example, imidizing a polyimide resin precursor) to form a resin film, and
a step of removing the resin film from the mold.

The resin film removed from the mold is used as an endless belt.

Here, although there is no particular limitation, a cylindrical mold is used as the mold. A metal substrate may be used. In addition, as the mold, a mold made of a material other than metal, such as a resin, glass, or ceramic, may be used. In addition, a glass coating, a ceramic coating, or the like may be provided on the surface of the mold, or a silicone-based or fluorine-based release agent may be applied.

Examples of the method of applying the resin solution include usual methods such as a blade coating method, a wire bar coating method, a spray coating method, a dip coating method, a bead coating method, an air knife coating method, and a curtain coating method.

Here, in the method of manufacturing the endless belt according to the present exemplary embodiment, for example, the following operation may be carried out. These operations make it easier to control the average value of the areas of the Voronoi polygons, the standard deviation of the areas of the Voronoi polygons, the average dispersion size of the conductive particles, and the average value of the nearest-neighbor distance distribution of the conductive particles within the above-described ranges.
Operation of dispersing conductive particles (particularly, carbon black) in a resin solution under an ultra-high pressure
Operation of adding a resin solution and a dispersant of conductive particles (particularly, carbon black)
Operation of pre-dispersing conductive particles (particularly, carbon black) into fine particles using a media disperser

### Use of Endless Belt

The endless belt according to the present exemplary embodiment can be used as, for example, an endless belt for an electrophotographic image forming apparatus. Examples of the endless belt for the electrophotographic image forming apparatus include an intermediate transfer belt, a transfer belt (that is, a recording medium transport belt), a fixing belt (such as a heating belt or a pressure belt), and a transport belt (that is, a recording medium transport belt).

The endless belt according to the present exemplary embodiment can also be used as, for example, a belt-like member such as a transport belt, a driving belt, a laminated belt, an electric insulating material, a pipe coating material, an electromagnetic wave insulating material, a heat source insulator, or an electromagnetic wave absorbent film, in addition to the endless belt for the image forming apparatus.

Depending on the use, the endless belt according to the present exemplary embodiment may include a functional layer provided on the outer peripheral surface side or the inner peripheral surface side. It should be noted that the endless belt according to the present exemplary embodiment may be used as, for example, a resin substrate layer.

### Transfer Device

The transfer device according to the present exemplary embodiment includes an intermediate transfer belt having an outer peripheral surface onto which a toner image is transferred, a primary transfer device having a primary transfer member that primarily transfers a toner image formed on a surface of an image holder onto the outer peripheral surface of the intermediate transfer belt, and a secondary transfer device having a secondary transfer member that is arranged in contact with the outer peripheral surface of the intermediate transfer belt and that secondarily transfers the toner image transferred onto the outer peripheral surface of the intermediate transfer belt onto a surface of a recording medium.

As the intermediate transfer belt, an intermediate transfer belt including the endless belt according to the present exemplary embodiment is used.

The transfer device according to the present exemplary embodiment may include a known device such as a cleaning device including a cleaning member that cleans the outer peripheral surface of the intermediate transfer belt.

### Intermediate Transfer Belt

The intermediate transfer belt includes the aforementioned endless belt according to the present exemplary embodiment.

The intermediate transfer belt may be a single layer of an endless belt, or may be a laminate in which the endless belt is used as a resin substrate layer. The laminate may be, for example, a laminate having a resin substrate layer, an elastic layer provided on the resin substrate layer, and a release layer provided on the elastic layer, or a laminate having a resin substrate layer and a release layer provided on the resin substrate layer.

The elastic layer will be described.

The elastic layer contains a heat-resistant elastic material.

Examples of the heat-resistant elastic material include silicone rubber and fluororubber.

Examples of the silicone rubber include room-temperature vulcanizing (RTV) silicone rubber, high temperature vulcanizing (HTV) silicone rubber, and liquid silicone rubber. Specific examples thereof include polydimethyl silicone rubber, methylvinyl silicone rubber, methylphenyl silicone rubber, and fluorosilicone rubber.

Examples of the fluororubber include vinylidene fluoride-based rubber, ethylene tetrafluoride/propylene-based rubber, ethylene tetrafluoride/perfluoromethylvinyl ether rubber, phosphazene-based rubber, and fluoropolyether.

The elastic layer may contain other components. Examples of such other components include a filler, a conductive agent, a softener (such as a paraffin-based softener), a processing aid (such as stearic acid), an antioxidant (such as an amine-based antioxidant), a vulcanizing agent (such as sulfur, a metal oxide, and a peroxide), and a functional filler (such as alumina).

The release layer will be described.

The release layer contains, for example, a heat-resistant release material.

Examples of the heat-resistant release material include fluororubber, a fluororesin, a silicone resin, and a polyimide resin.

Among these, as the heat-resistant release material, for example, a fluororesin is preferable. Specific examples of the fluororesin include a tetrafluoroethylene/perfluoroalkylvinyl ether copolymer (PFA), polytetrafluoroethylene (PTFE), a tetrafluoroethylene/hexafluoropropylene copolymer (FEP), a polyethylene/tetrafluoroethylene copolymer (ETFE), polyvinylidene fluoride (PVDF), polychlorotrifluoroethylene (PCTFE), and vinyl fluoride (PVF).

The intermediate transfer belt has a known configuration, except for the endless belt according to the present exemplary embodiment.

### Volume Resistivity of Intermediate Transfer Belt

The common logarithm of the volume resistivity of the intermediate transfer belt in a case where a voltage of 100 V is applied for 10 seconds is, for example, preferably 8.0 (log Ω·cm) or more and 13.5 (log Ω·cm) or less, and more preferably 8.5 (log Ω·cm) or more and 13.2 (log Ω·cm) or less.

The volume resistivity of the intermediate transfer belt in a case where a voltage of 500 V is applied for 10 seconds is measured by the following method.

Using a microammeter (R8430A manufactured by ADVANTEST CORPORATION) as a resistance meter and a UR probe (manufactured by Mitsubishi Chemical Analytech Co., Ltd.) as a probe, the volume resistivity (log Ω cm) is measured at 18 points in total, that is, six points at equal intervals in the circumferential direction of the intermediate transfer belt, and three points in the width direction at the central portion and both end portions, at a voltage of 100 V under a pressure of 1 kgf for a voltage application time of 10 seconds, and an average value thereof is calculated. The volume resistivity is measured in an environment of a temperature of 22 °C and a humidity of 55% RH.

### Surface Resistivity of Intermediate Transfer Belt

The common logarithm of the surface resistivity of the intermediate transfer belt in a case where a voltage of 100 V is applied to the outer peripheral surface of the intermediate transfer belt for 10 seconds is, for example, preferably 9.5 (log Ω/suq.) or more and 15.0 (log Ω/suq.) or less, more preferably 10.5 (log Ω/suq.) or more and 14.0 (log Ω/suq.) or less, and particularly preferably 11.0 (log Ω/suq.) or more and 13.5 (log Ω/suq.) or less.

The unit log Ω/suq. of the surface resistivity represents the surface resistivity as a logarithmic value of a resistance value per unit area, which is also written as log(Ω/suq.), log Ω/square, log Ω/Q, or the like.

The surface resistivity of the intermediate transfer belt in a case where a voltage of 100 V is applied to the outer peripheral surface of the intermediate transfer belt for 10 seconds is measured by the following method.

Using a microammeter (R8430A manufactured by ADVANTEST CORPORATION) as a resistance meter and a UR probe (manufactured by Mitsubishi Chemical Analytech Co., Ltd.) as a probe, the surface resistivity (log Ω/suq.) of the outer peripheral surface of the endless belt is measured at 18 points in total, that is, six points at equal intervals in the circumferential direction of the outer peripheral surface of the intermediate transfer belt, and three points in the width direction at the central portion and both end portions, at a voltage of 100 V under a pressure of 1 kgf for a voltage application time of 10 seconds, and an average thereof is calculated. The surface resistivity is measured in an environment of a temperature of 22 °C and a humidity of 55% RH.

### Primary Transfer Device

In the primary transfer device, the primary transfer member is arranged to face the image holder across the intermediate transfer belt. In the primary transfer device, the primary transfer member applies a voltage with a polarity opposite to the charge polarity of a toner to the intermediate transfer belt, thereby primarily transferring the toner image onto the outer circumferential surface of the intermediate transfer belt.

### Secondary Transfer Device

In the secondary transfer device, the secondary transfer member is arranged on a toner image-holding side of the intermediate transfer belt. The secondary transfer device includes, for example, a secondary transfer member and a back surface member that is arranged on the side opposite to the toner image-holding side of the intermediate transfer belt. In the secondary transfer device, the intermediate transfer belt and the recording medium are sandwiched between the secondary transfer member and the back surface member to form a transfer electric field, thereby secondarily transferring the toner image on the intermediate transfer belt onto the recording medium.

The secondary transfer member may be a secondary transfer roll or a secondary transfer belt. As the back surface member, for example, a back roll is used.

### Cleaning Device

In the cleaning device, the cleaning member is arranged on the toner image-holding side of the intermediate transfer belt. The cleaning device includes, for example, the cleaning member and a back surface member that is arranged on the side opposite to the toner image-holding side of the intermediate transfer belt. In the cleaning device, for example, in a state where the intermediate transfer belt is interposed between the cleaning member and the back surface member, the cleaning member cleans the outer peripheral surface of the intermediate transfer belt.

Examples of the cleaning member include a cleaning blade and a cleaning brush.

The transfer device according to the present exemplary embodiment may be a transfer device that transfers a toner image onto the surface of a recording medium via a plurality of intermediate transfer bodies. That is, the transfer device may be, for example, a transfer device that primarily transfers a toner image onto a first intermediate transfer body from an image holder, secondarily transfers the toner image onto a second intermediate transfer body from the first intermediate transfer body, and then tertiarily transfers the toner image onto a recording medium from the second intermediate transfer body.

In the transfer device, the intermediate transfer belt including the endless belt according to the present exemplary embodiment is applied to at least one of the plurality of intermediate transfer bodies.

### Image Forming Apparatus

The image forming apparatus according to the present exemplary embodiment includes a toner image forming device that forms a toner image on a surface of an image holder and a transfer device that transfers the toner image formed on the surface of the image holder onto a surface of a recording medium. As the transfer device, the transfer device according to the present exemplary embodiment described above is used.

Examples of the toner image forming device include a device that includes an image holder, a charging device that charges the surface of the image holder, an electrostatic latent image forming device that forms an electrostatic latent image on the charged surface of the image holder, and a developing device that develops the electrostatic latent image formed on the surface of the image holder with a developer containing a toner to form a toner image.

As the image forming apparatus according to the present exemplary embodiment, known image forming apparatuses are used, such as an apparatus including a fixing device that fixes the toner image transferred onto the surface of the recording medium; an apparatus including a cleaning device that cleans the surface of the image holder before charging after the transfer of the toner image; an apparatus including a charge removal device that, after the transfer of the toner image and before charging, irradiates the surface of the image holder with charge-removal light to remove electric charges; and an apparatus including an image holder heating member that raises a temperature of the image holder to reduce a relative temperature.

The image forming apparatus according to the present exemplary embodiment may be either a dry development type image forming apparatus or a wet development type image forming apparatus (a development type using a liquid developer).

In the image forming apparatus according to the present exemplary embodiment, for example, a portion including the image holder may be a cartridge structure (process cartridge) detachable from the image forming apparatus. As the process cartridge, for example, a process cartridge including a toner image forming device and a transfer device is used.

Hereinafter, an example of the image forming apparatus according to the present exemplary embodiment will be described with reference to drawings. It should be noted that the image forming apparatus according to the present exemplary embodiment is not limited to this. Further, major parts shown in the drawings will be described, but description of the rest will be omitted.

### Image Forming Apparatus

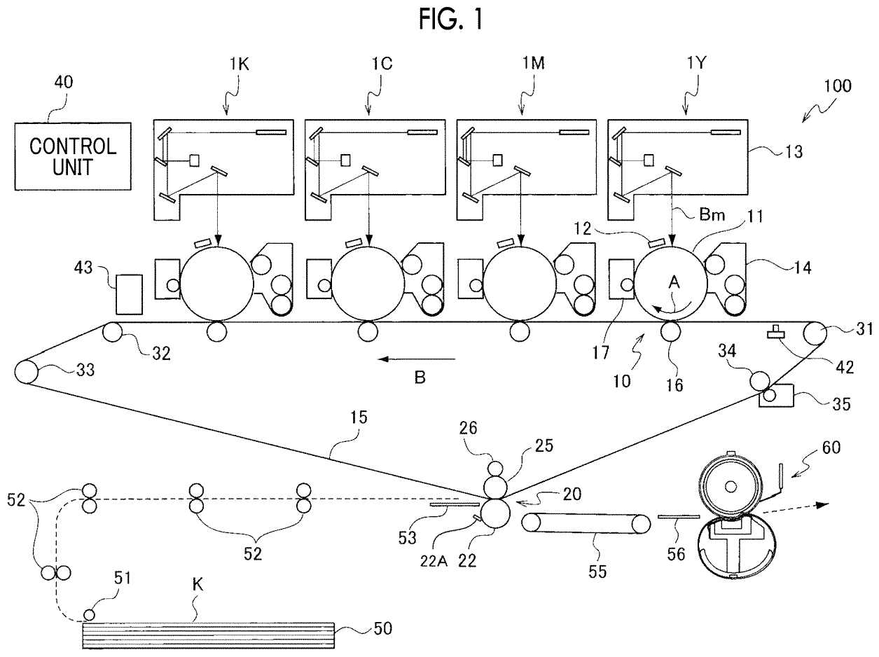

FIG. 1 is a schematic configuration diagram showing a configuration of the image forming apparatus according to the present exemplary embodiment.

As shown in FIG. 1, an image forming apparatus 100 according to the present exemplary embodiment is, for example, an intermediate transfer type image forming apparatus that is generally called a tandem type, and includes a plurality of image forming units 1Y, 1M, 1C, and 1K (an example of a toner image forming device) that form toner images of the respective color components by an electrophotographic method, a primary transfer portion 10 that sequentially transfers (primarily transfers) the toner image of each color component formed by each of the image forming units 1Y, 1M, 1C, and 1K onto an intermediate transfer belt 15, a secondary transfer portion 20 that collectively transfers (secondarily transfers) the superimposed toner images transferred onto the intermediate transfer belt 15 onto paper K as a recording medium, and a fixing device 60 that fixes the images transferred by the secondary transfer onto the paper K. In addition, the image forming apparatus 100 includes a control unit 40 that controls the operation of each device (each portion).

Each of the image forming units 1Y, 1M, 1C, and 1K of the image forming apparatus 100 includes a photoreceptor 11 (an example of an image holder) that holds the toner image formed on the surface thereof and that rotates in a direction of an arrow A.

Around the photoreceptor 11, a charger 12 for charging the photoreceptor 11 is provided as an example of charging means, and a laser exposure machine 13 for writing an electrostatic latent image on the photoreceptor 11 (an exposure beam is represented by a reference numeral Bm in the drawing) is provided as an example of an electrostatic latent image forming device.

In addition, around the photoreceptor 11, as an example of developing means, a developing machine 14 that accommodates toner of each color component and visualizes the electrostatic latent image on the photoreceptor 11 with the toner is provided, and a primary transfer roll 16 that transfers the toner image of each color component formed on the photoreceptor 11 onto the intermediate transfer belt 15 by the primary transfer portion 10 is provided.

Further, a photoreceptor cleaner 17 that removes the residual toner on the photoreceptor 11 is provided around the photoreceptor 11, and devices for electrophotography, such as the charger 12, the laser exposure machine 13, the developing machine 14, the primary transfer roll 16, and a photoreceptor cleaner 17, are arranged in sequence along a rotation direction of the photoreceptor 11. These image forming units 1Y, 1M, 1C, and 1K are substantially linearly arranged in order of yellow (Y), magenta (M), cyan (C), and black (K) from the upstream side of the intermediate transfer belt 15.

The intermediate transfer belt 15 is driven to circulate (rotate) by various rolls in a direction of an arrow B shown in FIG. 1 at a speed suited to the purpose. The image forming apparatus 100 has, as the various rolls, a drive roll 31 that is driven by a motor (not shown) excellent in maintaining a constant speed and that rotates the intermediate transfer belt 15, a support roll 32 that supports the intermediate transfer belt 15 substantially linearly extending along an arrangement direction of each photoreceptor 11, a tension applying roll 33 that applies tension to the intermediate transfer belt 15 and that functions as a correcting roll preventing meandering of the intermediate transfer belt 15, a back roll 25 that is provided in the secondary transfer portion 20, and a cleaning back roll 34 that is provided in a cleaning portion scrapping off the residual toner on the intermediate transfer belt 15.

The primary transfer portion 10 is configured with the primary transfer roll 16 that is arranged to face the photoreceptor 11 across the intermediate transfer belt 15. The primary transfer roll 16 is arranged to be pressed against the photoreceptor 11 across the intermediate transfer belt 15. Furthermore, a voltage with a polarity (primary transfer bias) opposite to the charge polarity (negative polarity, the same applies hereinafter) of the toner is applied to the primary transfer roll 16. As a result, the toner images on the respective photoreceptors 11 are sequentially electrostatically attracted to the intermediate transfer belt 15, and the superimposed toner images are formed on the intermediate transfer belt 15.

The secondary transfer portion 20 includes the back roll 25 and a secondary transfer roll 22 that is arranged on a toner image-holding surface side of the intermediate transfer belt 15.

The back roll 25 is formed such that the surface resistivity thereof is 1×10⁷ Ω/□ or more and 1×10¹⁰Ω/□ or less. The hardness of the back roll 25 is set to, for example, 700 (ASKER C: manufactured by KOBUNSHI KEIKI CO., LTD., the same applies hereinafter). The back roll 25 is arranged on the back surface side of the intermediate transfer belt 15 to configure a counter electrode of the secondary transfer roll 22, and a power supply roll 26 made of a metal to which secondary transfer bias is stably applied is arranged to come into contact with the back roll 25.

On the other hand, the secondary transfer roll 22 is a cylindrical roll having a volume resistivity of 10^{7.5} Ω·cm or more and 10^{8.5} Ω·cm or less. The secondary transfer roll 22 is arranged to be pressed on the back roll 25 across the intermediate transfer belt 15. The secondary transfer roll 22 is grounded such that the secondary transfer bias is formed between the secondary transfer roll 22 and the back roll 25, which induces secondary transfer of the toner image onto the paper K transported to the secondary transfer portion 20.

In addition, on the downstream side of the secondary transfer portion 20 of the intermediate transfer belt 15, an intermediate transfer belt cleaning member 35 is provided so as to be freely contactable and detachable, which removes the residual toner and paper dust from the intermediate transfer belt 15 remaining after the secondary transfer and cleans the outer peripheral surface of the intermediate transfer belt 15.

In addition, on the downstream side of the secondary transfer portion 20 of the secondary transfer roll 22, a secondary transfer roll cleaning member 22A is provided which removes the residual toner and paper dust from the secondary transfer roll 22 remaining after the secondary transfer and cleans the outer peripheral surface of the intermediate transfer belt 15. Examples of the secondary transfer roll cleaning member 22A include a cleaning blade. It should be noted that the secondary transfer roll cleaning member 22A may be a cleaning roll.

The intermediate transfer belt 15, the primary transfer roll 16, the secondary transfer roll 22, and the intermediate transfer belt cleaning member 35 correspond to an example of the transfer device.

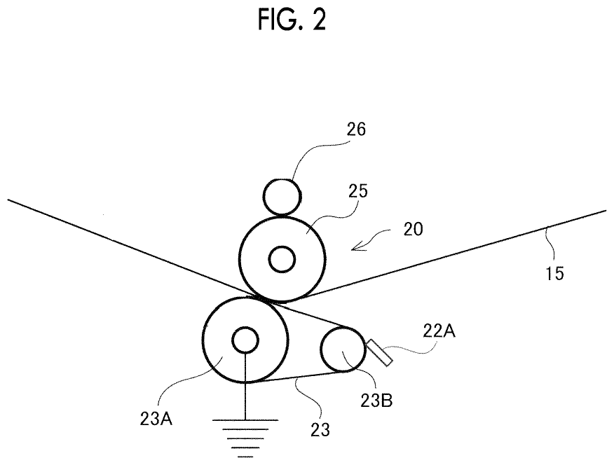

Here, the image forming apparatus 100 may have a configuration in which the apparatus includes a secondary transfer belt (an example of a secondary transfer member) instead of the secondary transfer roll 22. Specifically, as shown in FIG. 2, the image forming apparatus 100 may include a secondary transfer device including a secondary transfer belt 23, a drive roll 23A that is arranged to face the back roll 25 via the intermediate transfer belt 15 and the secondary transfer belt 23, and an idler roll 23B that stretches the secondary transfer belt 23 together with the drive roll 23A.

On the other hand, on the upstream side of the yellow image forming unit 1Y, a reference sensor (home position sensor) 42 is disposed which generates a reference signal to be a reference for taking the image forming timing in each of the image forming units 1Y, 1M, 1C, and 1K. On the downstream side of the black image forming unit 1K, an image density sensor 43 for adjusting image quality is disposed. The reference sensor 42 recognizes a mark provided on the back side of the intermediate transfer belt 15 and generates a reference signal. Each of the image forming units 1Y, 1M, 1C, and 1K is configured such that these units start to form images according to the instruction from the control unit 40 based on the recognition of the reference signal.

Further, the image forming apparatus according to the present exemplary embodiment includes, as transport means for transporting the paper K, a paper storage portion 50 that stores the paper K, a paper feeding roll 51 that takes out and transports the paper K stacked in the paper storage portion 50 at a predetermined timing, a transport roll 52 that transports the paper K transported by the paper feeding roll 51, a transport guide 53 that sends the paper K transported by the transport roll 52 to the secondary transfer portion 20, a transport belt 55 that transports the paper K transported after going through secondary transfer by the secondary transfer roll 22 to the fixing device 60, and a fixing inlet guide 56 that guides the paper K to the fixing device 60.

Next, a basic image forming process of the image forming apparatus according to the present exemplary embodiment will be described.

In the image forming apparatus according to the present exemplary embodiment, image data output from an image reading device (not shown), a personal computer (PC) (not shown), or the like is subjected to image processing by an image processing device (not shown), and then the image forming units 1Y, 1M, 1C, and 1K perform the image forming operation.

In the image processing device, image processing, such as shading correction, misregistration correction, brightness/color space conversion, gamma correction, or various image editing works such as frame erasing or color editing and movement editing, is performed on the input image data. The image data that has undergone the image processing is converted into color material gradation data of 4 colors, Y, M, C, and K, and is output to the laser exposure machine 13.

In the laser exposure machine 13, for example, the photoreceptor 11 of each of the image forming units 1Y, 1M, 1C, and 1K is irradiated with the exposure beam Bm emitted from a semiconductor laser in accordance with the input color material gradation data. The surface of the photoreceptor 11 of each of the image forming units 1Y, 1M, 1C, and 1K is charged by the charger 12 and then scanned and exposed by the laser exposure machine 13. In this way, an electrostatic latent image is formed. By each of the image forming units 1Y, 1M, 1C, and 1K, the formed electrostatic latent image is developed as a toner image of each of the colors Y, M, C, and K.

In the primary transfer portion 10 where each photoreceptor 11 and the intermediate transfer belt 15 come into contact with each other, the toner images formed on the photoreceptors 11 of the image forming units 1Y, 1M, 1C, and 1K are transferred onto the intermediate transfer belt 15. More specifically, in the primary transfer portion 10, by the primary transfer roll 16, a voltage (primary transfer bias) with a polarity opposite to the charge polarity (negative polarity) of the toner is applied to the substrate of the intermediate transfer belt 15, and the toner images are sequentially overlapped on the outer peripheral surface of the intermediate transfer belt 15 and subjected to primary transfer.

After the primary transfer by which the toner images are sequentially transferred onto the outer peripheral surface of the intermediate transfer belt 15, the intermediate transfer belt 15 moves, and the toner images are transported to the secondary transfer portion 20. In a case where the toner images are transported to the secondary transfer portion 20, in the transport means, the paper feeding roll 51 rotates in accordance with the timing at which the toner images are transported to the secondary transfer portion 20, and the paper K having the target size is fed from the paper storage portion 50. The paper K fed from the paper feeding roll 51 is transported by the transport roll 52, passes through the transport guide 53, and reaches the secondary transfer portion 20. Before reaching the secondary transfer portion 20, the paper K is temporarily stopped, and a positioning roll (not shown) rotates in accordance with the movement timing of the intermediate transfer belt 15 holding the toner images, so that the position of the paper K is aligned with the positions of the toner images.

In the secondary transfer portion 20, via the intermediate transfer belt 15, the secondary transfer roll 22 is pressed on the back roll 25. In this case, the paper K transported in synchronization with the timing is sandwiched between the intermediate transfer belt 15 and the secondary transfer roll 22. In this case, in a case where a voltage (secondary transfer bias) with the same polarity as the charge polarity (negative polarity) of the toner is applied from the power supply roll 26, a transfer electric field is formed between the secondary transfer roll 22 and the back roll 25. Then, in the secondary transfer portion 20 pressed by the secondary transfer roll 22 and the back roll 25, the unfixed toner images held on the intermediate transfer belt 15 are collectively electrostatically transferred onto the paper K.

Thereafter, the paper K onto which the toner images are electrostatically transferred is transported as it is in a state of being peeled off from the intermediate transfer belt 15 by the secondary transfer roll 22, and is transported to the transport belt 55 provided downstream of the secondary transfer roll 22 in a paper transport direction. The transport belt 55 transports the paper K to the fixing device 60 in accordance with an optimal transport speed in the fixing device 60. The unfixed toner images on the paper K transported to the fixing device 60 are fixed on the paper K by being subjected to a fixing process with heat and pressure by the fixing device 60. Then, the paper K on which a fixed image is formed is transported to a discharged paper-storage portion (not shown) provided in a discharge portion of the image forming apparatus.

Meanwhile, after the transfer to the paper K is finished, the residual toner remaining on the intermediate transfer belt 15 is transported to the cleaning portion as the intermediate transfer belt 15 rotates, and is removed from the intermediate transfer belt 15 by the cleaning back roll 34 and the intermediate transfer belt cleaning member 35.

Hitherto, the present exemplary embodiment has been described. However, the present exemplary embodiment is not limited to the above exemplary embodiments, and various modifications, changes, and improvements are possible.

### EXAMPLES

Examples of the present invention will be described below, but the present invention is not limited to the following examples. In the following description, all “parts” and “%” are in terms of mass unless otherwise specified.

### Synthesis of Polyamic Acid

### Preparation of Polyamic Acid Solution DA-A1

A polyamic acid DA-A1 and a polyamic acid solution DA-A1 containing the polyamic acid DA-A1 are synthesized as a polyamic acid having amino groups at all terminals (that is, a polyamic acid having amino groups at both terminals of a molecular chain) by the following method.

As a diamine compound, 83.48 g (416.9 mmol) of 4,4′-diaminodiphenyl ether (hereinafter, abbreviated to “ODA”) is added to 800 g of N-methyl-2-pyrrolidone (hereinafter, abbreviated to “NMP”) and dissolved while being stirred at room temperature (25 °C).

Next, as tetracarboxylic dianhydride, 116.52 g (396.0 mmol) of 3,3′,4,4′-biphenyltetracarboxylic dianhydride (hereinafter abbreviated to “BPDA”) is gradually added thereto. After the addition and dissolution of the tetracarboxylic dianhydride, the temperature of the reaction solution is raised to 60 °C, and then a polymerization reaction is carried out for 20 hours in a state where the reaction temperature is maintained, thereby obtaining a reaction solution containing the polyamic acid DA-A1 and NMP.

The obtained reaction solution is filtered using a #800 stainless steel mesh and cooled to room temperature (25 °C), thereby obtaining a polyamic acid solution DA-A1.

### Preparation of Polyamic Acid Solution DC-A1

A polyamic acid DC-A1 and a polyamic acid solution DC-A1 containing the polyamic acid DC-A1 are synthesized as a polyamic acid having carboxy groups at all terminals (that is, a polyamic acid having carboxy groups at both terminals of a molecular chain) by the following method.

A reaction solution containing the polyamic acid DC-A1 and NMP is obtained in the same manner as in the polyamic acid DA-A1, except that the amount of ODA is changed to 79.57 g (397.4 mmol) and the amount of BPDA is changed to 120.43 g (409.3 mmol).

Then, the obtained reaction solution is filtered using a #800 stainless steel mesh and cooled to room temperature (25 °C), thereby obtaining a polyamic acid solution DC-A1.

### Preparation of Conductive Particles

### COLOUR BLACK FW1

“COLOUR BLACK FW1” (average primary particle size=13 nm, amount of surface functional groups determined by back titration with NaHCO₃=0.20 mmol/g) manufactured by Orion Engineered Carbons S.A. is prepared.

### Acid-Treated Product 1 of COLOUR BLACK FW1

The “COLOUR BLACK FW1” manufactured by Orion Engineered Carbons S.A. is subjected to a liquid phase treatment with nitric acid to obtain an acid-treated product 1 of COLOUR BLACK FW1 (average primary particle size=13 nm, amount of surface functional groups determined by back titration with NaHCO₃=0.60 mmol/g).

It should be noted that the amount of surface functional groups is adjusted by changing the concentration of the nitric acid during the acid treatment.

### Acid-Treated Product 2 of COLOUR BLACK FW1

The “COLOUR BLACK FW1” manufactured by Orion Engineered Carbons S.A. is subjected to a liquid phase treatment with nitric acid to obtain an acid-treated product 2 of COLOUR BLACK FW1 (average primary particle size=13 nm, amount of surface functional groups determined by back titration with NaHCO₃=0.40 mmol/g).

It should be noted that the amount of surface functional groups is adjusted by changing the concentration of the nitric acid during the acid treatment.

### Acid-Treated Product 3 of COLOUR BLACK FW1

The “COLOUR BLACK FW1” manufactured by Orion Engineered Carbons S.A. is subjected to a liquid phase treatment with nitric acid to obtain an acid-treated product 3 of COLOUR BLACK FW1 (average primary particle size=13 nm, amount of surface functional groups determined by back titration with NaHCO₃=0.65 mmol/g).

It should be noted that the amount of surface functional groups is adjusted by changing the concentration of the nitric acid during the acid treatment.

### Acid-Treated Product 4 of COLOUR BLACK FW1

The “COLOUR BLACK FW1” manufactured by Orion Engineered Carbons S.A. is subjected to a liquid phase treatment with nitric acid to obtain an acid-treated product 4 of COLOUR BLACK FW1 (average primary particle size=13 nm, amount of surface functional groups determined by back titration with NaHCO₃=0.32 mmol/g).

It should be noted that the amount of surface functional groups is adjusted by changing the concentration of the nitric acid during the acid treatment.

### Acid-Treated Product 5 of COLOUR BLACK FW1

The “COLOUR BLACK FW1” manufactured by Orion Engineered Carbons S.A. is subjected to a liquid phase treatment with nitric acid to obtain an acid-treated product 5 of COLOUR BLACK FW1 (average primary particle size=13 nm, amount of surface functional groups determined by back titration with NaHCO₃=0.28 mmol/g).

It should be noted that the amount of surface functional groups is adjusted by changing the concentration of the nitric acid during the acid treatment.

### COLOUR BLACK FW2

“COLOUR BLACK FW2 (average primary particle size=13 nm, amount of surface functional groups determined by back titration with NaHCO₃=0.45 mmol/g)” manufactured by Orion Engineered Carbons S.A. is prepared.

### COLOUR BLACK FW200

“COLOUR BLACK FW200 (average primary particle size=13 nm, amount of surface functional groups determined by back titration with NaHCO₃=0.90 mmol/g)” manufactured by Orion Engineered Carbons S.A. is prepared.

### COLOUR BLACK FW310

“COLOUR BLACK FW310 (average primary particle size=9 nm, amount of surface functional groups determined by back titration with NaHCO₃=0.30 mmol/g)” manufactured by Orion Engineered Carbons S.A. is prepared.

### Example 1

### Production of Coating Liquid

COLOUR BLACK FW2 as conductive particles and aralkyl-modified silicone oil (KF-410 manufactured by Shin-Etsu Chemical Co., Ltd.) as a silicone oil are added to the polyamic acid solution DA-A1 (solid content amount: 18% by mass) to obtain a dispersion liquid.

Here, the amount of the conductive particles and the amount of the silicone oil are set to the amounts shown in Table 1 (parts per 100 parts by mass of the polyimide resin after imidization of the polyamic acid).

Next, the dispersion liquid is passed through an orifice having a diameter of 0.1 mm at a pressure of 220 MPa using a high-pressure collision type disperser (JOKOH Co., Ltd.), and the two divided slurries are collided with each other 10 times to be dispersed, thereby obtaining a coating liquid.

### Manufacturing of Endless Belt

An aluminum cylindrical body having an outer diameter of 430 mm and a length of 600 mm is prepared. The coating liquid is discharged onto an outer peripheral surface of the cylindrical body through a dispenser such that the coating liquid is applied in a width of 500 mm and with a thickness of 80 km.

The cylindrical body on which a coating film is formed is heated at a temperature of 140 °C for 30 minutes while being kept horizontal, and the coating film is dried.

By heating the dried coating film for 120 minutes such that the maximum temperature reaches 320 °C, a polyimide resin film is formed.

The polyimide resin film is peeled off from the mold by being manually removed from the mold. An axial center portion of the polyimide resin film is cut to have a width of 363 mm to obtain an endless belt having a thickness of 80 μm.

### Example 2

An endless belt is obtained in the same manner as in Example 1, except that the amount of the conductive particles and the amount of the silicone oil are adjusted to the amounts shown in Table 1 (parts per 100 parts by mass of the polyimide resin after imidization of the polyamic acid).

### Example 3

An endless belt is obtained in the same manner as in Example 1, except that the acid-treated product 1 of COLOUR BLACK FW1 is used as the conductive particles, and the amount of the conductive particles and the amount of the silicone oil are adjusted to the amounts shown in Table 1 (parts per 100 parts by mass of the polyimide resin after imidization of the polyamic acid).

### Example 4

An endless belt is obtained in the same manner as in Example 1, except that the acid-treated product 2 of COLOUR BLACK FW1 is used as the conductive particles, and the amount of the conductive particles and the amount of the silicone oil are adjusted to the amounts shown in Table 1 (parts per 100 parts by mass of the polyimide resin after imidization of the polyamic acid).

### Example 5

An endless belt is obtained in the same manner as in Example 1, except that the acid-treated product 3 of COLOUR BLACK FW1 is used as the conductive particles, and the amount of the conductive particles and the amount of the silicone oil are adjusted to the amounts shown in Table 1 (parts per 100 parts by mass of the polyimide resin after imidization of the polyamic acid).

### Example 6

An endless belt is obtained in the same manner as in Example 1, except that the acid-treated product 4 of COLOUR BLACK FW1 is used as the conductive particles, and the amount of the conductive particles and the amount of the silicone oil are adjusted to the amounts shown in Table 1 (parts per 100 parts by mass of the polyimide resin after imidization of the polyamic acid).

### Example 7

An endless belt is obtained in the same manner as in Example 1, except that the amount of the conductive particles and the amount of the silicone oil are adjusted to the amounts shown in Table 1.

### Example 8

An endless belt is obtained in the same manner as in Example 1, except that the silicone oil is not used, and the amount of the conductive particles is adjusted to the amount shown in Table 1.

### Example 9

An endless belt is obtained in the same manner as in Example 1, except that the acid-treated product 5 of COLOUR BLACK FW1 is used as the conductive particles, and the amount of the conductive particles and the amount of the silicone oil are adjusted to the amounts shown in Table 1 (parts per 100 parts by mass of the polyimide resin after imidization of the polyamic acid).

### Example 10

An endless belt is obtained in the same manner as in Example 1, except that DC-A1 (solid content amount: 18% by mass) is used as the polyamic acid solution, and the amount of the conductive particles and the amount of the silicone oil are adjusted to the amounts shown in Table 1 (parts per 100 parts by mass of the polyimide resin after imidization of the polyamic acid).

### Example 11

An endless belt is obtained in the same manner as in Example 1, except that the amount of the conductive particles and the amount of the silicone oil are adjusted to the amounts shown in Table 1.

### Example 12

An endless belt is obtained in the same manner as in Example 1, except that the amount of the conductive particles and the amount of the silicone oil are adjusted to the amounts shown in Table 1.

### Example 13

An endless belt is obtained in the same manner as in Example 1, except that the amount of the conductive particles and the amount of the silicone oil are adjusted to the amounts shown in Table 1.

### Example 14

COLOUR BLACK FW2 as conductive particles and aralkyl-modified silicone oil (KF-410 manufactured by Shin-Etsu Chemical Co., Ltd.) as a silicone oil are added to the polyamide-imide resin (product name: HPC-9000F-8L, manufactured by Resonac Holdings Corporation, referred to as “PAI” in the table) (solid content amount: 18% by mass) to obtain a dispersion liquid. The amount of the conductive particles and the amount of the silicone oil are adjusted to the amounts shown in Table 1 (parts per 100 parts by mass of the polyimide resin after imidization of the polyamic acid). An endless belt is obtained in the same manner as in Example 1, except for the above.

### Comparative Example 1

COLOUR BLACK FW200 as conductive particles and aralkyl-modified silicone oil (KF-410 manufactured by Shin-Etsu Chemical Co., Ltd.) as a silicone oil are added to the polyimide resin (product name: JIV300R, manufactured by JFE Chemical Corporation, referred to as “A” in the table) to obtain a dispersion liquid. The amount of the conductive particles and the amount of the silicone oil are adjusted to the amounts shown in Table 1 (parts per 100 parts by mass of the polyimide resin after imidization of the polyamic acid). An endless belt is obtained in the same manner as in Example 1, except for the above.

### Comparative Example 2

COLOUR BLACK FW1 as conductive particles and aralkyl-modified silicone oil (KF-410 manufactured by Shin-Etsu Chemical Co., Ltd.) as a silicone oil are added to the polyimide resin (product name: JIV300R, manufactured by JFE Chemical Corporation, referred to as “A” in the table) to obtain a dispersion liquid. The amount of the conductive particles and the amount of the silicone oil are adjusted to the amounts shown in Table 1 (parts per 100 parts by mass of the polyimide resin after imidization of the polyamic acid). An endless belt is obtained in the same manner as in Example 1, except for the above.

### Comparative Example 3

COLOUR BLACK FW200 as conductive particles is added to the polyamic acid solution DA-A1 (solid content amount: 18% by mass) to obtain a dispersion liquid. The amount of the conductive particles is adjusted to the amount shown in Table 1 (parts per 100 parts by mass of the polyimide resin after imidization of the polyamic acid). An endless belt is obtained in the same manner as in Example 1, except for the above.

### Comparative Example 4

COLOUR BLACK FW200 as conductive particles is added to the polyimide resin (product name: JIV300R, manufactured by JFE Chemical Corporation) (A) to obtain a dispersion liquid. The amount of the conductive particles is adjusted to the amount shown in Table 1 (parts per 100 parts by mass of the polyimide resin after imidization of the polyamic acid). An endless belt is obtained in the same manner as in Example 1, except for the above.

### Comparative Example 5

COLOUR BLACK FW310 as conductive particles is added to the polyimide resin (product name: JIV300R, manufactured by JFE Chemical Corporation, referred to as “A” in the table) to obtain a dispersion liquid. The amount of the conductive particles is adjusted to the amount shown in Table 1 (parts per 100 parts by mass of the polyimide resin after imidization of the polyamic acid). An endless belt is obtained in the same manner as in Example 1, except for the above.

### Comparative Example 6

COLOUR BLACK FW1 as conductive particles is added to the polyimide resin (product name: JIV300R, manufactured by JFE Chemical Corporation, referred to as “A” in the table) to obtain a dispersion liquid. The amount of the conductive particles is adjusted to the amount shown in Table 1 (parts per 100 parts by mass of the polyimide resin after imidization of the polyamic acid). An endless belt is obtained in the same manner as in Example 1, except for the above.

### Evaluation 1

### Characteristic Evaluation

The following characteristics of the endless belts of Examples 1, 2, 7, 8, and 16, and Comparative Examples 1 and 2 are measured according to the above-described methods.
Average value of areas of Voronoi polygons in Voronoi division using centroid of conductive particles as seed points
Average dispersion size of conductive particles
Average value of nearest-neighbor distance distribution of conductive particles

### Implementation Evaluation

The endless belts of Examples 1, 2, 7, 8, and 16, and Comparative Examples 1 and 2 are mounted as intermediate transfer belts in an evaluation image forming apparatus (“Revoria Press SC285” manufactured by Fujifilm Business Innovation Corporation).

Then, the following evaluation is carried out by the evaluation image forming apparatus.

### Transferability

Using the evaluation image forming apparatus, 10,000 half-tone images with a magenta image density of 50% are continuously printed on OZK (thickness: 188 μm) manufactured by DYNIC CORPORATION in a low temperature and low humidity environment (environment of a temperature of 10 °C and a humidity of 15%). Image quality before and after the start of printing is evaluated as follows. The image density of the last image is randomly measured at 10 points using an image density meter X-Rite938 (manufactured by X-Rite, Inc.), and an image density difference, which is a difference between a maximum value and a minimum value of the measured image density, is obtained.

The evaluation standards are as follows.

A+: The image density difference is 0.1 or less, and is not visible.

A: The image density difference is 0.2 or less, and is not visible.

B: The image density difference is more than 0.2, and 0.25 or less and is difficult to see.

B−: The image density difference is more than 0.25 and 0.3 or less, and is visible but within the allowable range.

C: The image density difference is more than 0.3, and is easily visible and is outside the allowable range.

### Breakage Resistance

Continuous running is performed in a no-paper state using the evaluation image forming apparatus. The number of rotation cycles until the intermediate transfer belt is broken during the continuous running is evaluated.

The evaluation standards are as follows.

A+: No breakage occurs in 2.4 million cycles or more.

A: Breakage occurs in 1.6 million cycles or more and less than 2.4 million cycles.

B: Breakage occurs in 800,000 million cycles or more and less than 1.6 million cycles.

B−: Breakage occurs in 480,000 million cycles or more and less than 800,000 million cycles.

C: Breakage occurs in 200,000 million cycles or more and less than 480,000 million cycles.

D: Breakage occurs in less than 200,000 cycles.

### Cleanability

Using the evaluation image forming apparatus, after outputting 10,000 sheets of a full-surface grid chart equivalent to 1% density on A4-sized plain paper in a high-temperature and high-humidity environment (28 °C and 85% RH), a 100% solid image in an untransferred state is introduced into a contact portion between the intermediate transfer belt and the blade, and then a streak-like cleaning defect portion is observed.

The evaluation standards are as follows.

A: No cleaning defects occur.

B: Cleaning defects are at a level that is not visible.

C: Cleaning defects are clearly visible.

### Evaluation 2

The endless belts of Examples 3 to 6 and 9 to 14, and Comparative Examples 3 to 6 are evaluated in the same manner as in Evaluation 1.

TABLE 1

| | Conductive particle | | | | | | | |
|---|---|---|---|---|---|---|---|---|
| | | | | Average | | | | |
| | Voronoi | Voronoi | | value of | | Amount | Average | |
| | area | area | Average | nearest- | | of surface | primary | |
| | average | standard | dispersion | neighbor | | functional | particle | |
| | value | deviation | size | distance | | groups | size | Amount |
| | [nm\hat{ }2] | [nm\hat{ }2] | [nm] | distribution | Type | [mmol/g] | [nm] | [parts] |
| Example 1 | 1450 | 1100 | 28 | 30 | FW2 | 0.45 | 13 | 24.0 |
| Example 2 | 1600 | 800 | 27 | 32 | FW2 | 0.45 | 13 | 22.0 |
| Example 3 | 1520 | 1050 | 25 | 29 | Acid- | 0.60 | 13 | 22.0 |
| | | | | | treated | | | |
| | | | | | product 1 | | | |
| | | | | | of FW1 | | | |
| Example 4 | 1550 | 900 | 26 | 31 | Acid- | 0.40 | 13 | 23.0 |
| | | | | | treated | | | |
| | | | | | product 2 | | | |
| | | | | | of FW1 | | | |
| Example 5 | 1550 | 1100 | 25 | 28 | Acid- | 0.65 | 13 | 21.0 |
| | | | | | treated | | | |
| | | | | | product 3 | | | |
| | | | | | of FW1 | | | |
| Example 6 | 1700 | 1200 | 29 | 35 | Acid- | 0.32 | 13 | 25.0 |
| | | | | | treated | | | |
| | | | | | product 4 | | | |
| | | | | | of FW1 | | | |
| Example 7 | 1790 | 1050 | 26 | 38 | FW2 | 0.45 | 13 | 20.0 |
| Example 8 | 1980 | 1100 | 29 | 40 | FW2 | 0.45 | 13 | 19.0 |
| Example 9 | 1800 | 1100 | 29 | 35 | Acid- | 0.28 | 13 | 22.0 |
| | | | | | treated | | | |
| | | | | | product 5 | | | |
| | | | | | of FW1 | | | |
| Example 10 | 1900 | 1150 | 30 | 40 | FW2 | 0.45 | 13 | 22.0 |
| Example 11 | 2000 | 1180 | 27 | 40 | FW2 | 0.45 | 13 | 15.8 |
| Example 12 | 1800 | 1100 | 27 | 38 | FW2 | 0.45 | 13 | 16.0 |
| Example 13 | 1400 | 900 | 27 | 35 | FW2 | 0.45 | 13 | 26.5 |
| Example 14 | 1900 | 1200 | 29 | 38 | FW2 | 0.45 | 13 | 22.0 |
| Comparative | 1800 | 900 | 32 | 35 | FW200 | 0.90 | 13 | 25.0 |
| Example 1 | | | | | | | | |
| Comparative | 1950 | 1300 | 38 | 40 | FW1 | 0.20 | 13 | 19.0 |
| Example 2 | | | | | | | | |
| Comparative | 1200 | 1000 | 27 | 31 | FW200 | 0.90 | 13 | 25.0 |
| Example 3 | | | | | | | | |
| Comparative | 2200 | 1150 | 29 | 40 | FW200 | 0.90 | 13 | 26.0 |
| Example 4 | | | | | | | | |
| Comparative | 1400 | 1100 | 17 | 19 | FW310 | 0.30 | 9 | 20.0 |
| Example 5 | | | | | | | | |
| Comparative | 2000 | 1150 | 39 | 45 | FW1 | 0.20 | 13 | 16.0 |
| Example 6 | | | | | | | | |

| | | Silicone oil | | Transferability | | | |
|---|---|---|---|---|---|---|---|
| | Resin | | Amount | | After | Breakage | |
| | Type | Type | [parts] | Initial | aging | resistance | Cleanability |
| Example 1 | DA-A1 | KF-410 | 0.2 | B− | B− | B− | B |
| Example 2 | DA-A1 | KF-410 | 1.0 | A+ | A+ | A+ | A |
| Example 3 | DA-A1 | KF-410 | 1.0 | A | A | A | A |
| Example 4 | DA-A1 | KF-410 | 1.0 | A | A | B | A |
| Example 5 | DA-A1 | KF-410 | 1.5 | A | B | A | A |
| Example 6 | DA-A1 | KF-410 | 1.0 | A | A | B | A |
| Example 7 | DA-A1 | KF-410 | 1.5 | A | B | B | A |
| Example 8 | DA-A1 | None | 0 | B− | B− | B− | B |
| Example 9 | DA-A1 | KF-410 | 1.0 | A | A | B− | A |
| Example 10 | DC-A1 | KF-410 | 1.0 | A | B | B− | A |
| Example 11 | DA-A1 | KF-410 | 1.0 | B | B | A+ | A |
| Example 12 | DA-A1 | KF-410 | 1.0 | B | B | A+ | A |
| Example 13 | DA-A1 | KF-410 | 1.0 | B | B | B | A |
| Example 14 | PAI | KF-410 | 1.0 | A | B− | D | A |
| Comparative | A | KF-410 | 1.0 | A | C | A | A |
| Example 1 | | | | | | | |
| Comparative | A | KF-410 | 1.0 | B | C | D | B |
| Example 2 | | | | | | | |
| Comparative | DA-A1 | None | None | B | C | A | B |
| Example 3 | | | | | | | |
| Comparative | A | None | None | C | C | C | C |
| Example 4 | | | | | | | |
| Comparative | A | None | None | C | C | C | C |
| Example 5 | | | | | | | |
| Comparative | A | None | None | B | C | D | C |
| Example 6 | | | | | | | |

From the above results, it can be seen that Examples are superior in both breakage resistance and transfer retention compared to Comparative Examples.

This also shows that the endless belts of Examples are superior in both breakage resistance and dispersibility of the conductive particles in the belt thickness direction compared to the endless belts of Comparative Examples.

The present exemplary embodiments include the following aspects.

(((1)))

An endless belt comprising:
a resin; and
conductive particles,
wherein, in a case where a cross section along a belt thickness direction is observed,
   in Voronoi division using centroids of the conductive particles as seed points, an average value of areas of Voronoi polygons is 1400 nm² or more and 2000 nm² or less, and a standard deviation of the areas of the Voronoi polygons is 1200 nm² or less,
   an average dispersion size of the conductive particles is 30 nm or less, and
   an average value of a nearest-neighbor distance distribution of the conductive particles is 20 nm or more and 40 nm or less.
      (((2)))

The endless belt according to (((1))),
wherein, in a case where the Voronoi division is performed using the centroids of the conductive particles as the seed points, the average value of the areas of the Voronoi polygons is 1600 nm² or more and 1800 nm² or less, the standard deviation of the areas of the Voronoi polygons is 1000 nm² or less,
the average dispersion size of the conductive particles is 27 nm or less, and
the average value of the nearest-neighbor distance distribution of the conductive particles is 30 nm or more and 35 nm or less.
   (((3)))

The endless belt according to (((1))) or (((2))),
wherein the conductive particles are carbon black.
   (((4)))

The endless belt according to (((3))),
wherein the carbon black has an amount of surface functional groups, as determined by back titration with NaHCO₃, of 0.3 mmol/g or more and 0.6 mmol/g or less.
   (((5)))

The endless belt according to (((3))) or (((4))),
wherein a content of the carbon black is 16 parts by mass or more and 26 parts by mass or less with respect to 100 parts by mass of the resin.
   (((6)))

The endless belt according to any one of (((1))) to (((5))),
wherein the resin is a polyimide resin.
   (((7)))

The endless belt according to (((6))),
wherein the polyimide resin is an imidized product of a polyamic acid having amino groups at all terminals.
   (((8)))

The endless belt according to any one of (((1))) to (((7))), further comprising:
at least one silicone oil selected from the group consisting of dimethyl silicone oil and modified silicone oil.
   (((9)))

An intermediate transfer belt comprising:
the endless belt according to any one of (((1))) to (((8))).
   (((10)))

A transfer device comprising:
an intermediate transfer belt having an outer peripheral surface onto which a toner image is transferred, the intermediate transfer belt including the endless belt according to any one of (((1))) to (((8)));
a primary transfer device having a primary transfer member that primarily transfers a toner image formed on a surface of an image holder onto the outer peripheral surface of the intermediate transfer belt; and
a secondary transfer device having a secondary transfer member that is arranged in contact with the outer peripheral surface of the intermediate transfer belt and that secondarily transfers the toner image transferred onto the outer peripheral surface of the intermediate transfer belt onto a surface of a recording medium.
   (((11)))

An image forming apparatus comprising:
a toner image forming device that has an image holder and that forms a toner image on a surface of the image holder; and
the transfer device according to (((10))), which transfers the toner image formed on the surface of the image holder onto a surface of a recording medium.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An endless belt comprising:
a resin; and
conductive particles,
wherein, in a case where a cross section along a belt thickness direction is observed,
in Voronoi division using centroids of the conductive particles as seed points, an average value of areas of Voronoi polygons is 1400 nm² or more and 2000 nm² or less, and a standard deviation of the areas of the Voronoi polygons is 1200 nm² or less,
an average dispersion size of the conductive particles is 30 nm or less, and
an average value of a nearest-neighbor distance distribution of the conductive particles is 20 nm or more and 40 nm or less.

2. The endless belt according to claim 1,
wherein, in a case where the Voronoi division is performed using the centroids of the conductive particles as the seed points, the average value of the areas of the Voronoi polygons is 1600 nm² or more and 1800 nm² or less, the standard deviation of the areas of the Voronoi polygons is 1000 nm² or less,
the average dispersion size of the conductive particles is 27 nm or less, and
the average value of the nearest-neighbor distance distribution of the conductive particles is 30 nm or more and 35 nm or less.

3. The endless belt according to claim 1,
wherein the conductive particles are carbon black.

4. The endless belt according to claim 3,
wherein the carbon black has an amount of surface functional groups, as determined by back titration with NaHCO₃, of 0.3 mmol/g or more and 0.6 mmol/g or less.

5. The endless belt according to claim 3,
wherein a content of the carbon black is 16 parts by mass or more and 26 parts by mass or less with respect to 100 parts by mass of the resin.

6. The endless belt according to claim 1,
wherein the resin is a polyimide resin.

7. The endless belt according to claim 6,
wherein the polyimide resin is an imidized product of a polyamic acid having amino groups at all terminals.

8. The endless belt according to claim 1, further comprising:
at least one silicone oil selected from the group consisting of dimethyl silicone oil and modified silicone oil.

9. An intermediate transfer belt comprising:
the endless belt according to claim 1.

10. An intermediate transfer belt comprising:
the endless belt according to claim 2.

11. An intermediate transfer belt comprising:
the endless belt according to claim 3.

12. An intermediate transfer belt comprising:
the endless belt according to claim 4.

13. An intermediate transfer belt comprising:
the endless belt according to claim 5.

14. An intermediate transfer belt comprising:
the endless belt according to claim 6.

15. An intermediate transfer belt comprising:
the endless belt according to claim 7.

16. An intermediate transfer belt comprising:
the endless belt according to claim 8.

17. A transfer device comprising:
an intermediate transfer belt having an outer peripheral surface onto which a toner image is transferred, the intermediate transfer belt including the endless belt according to claim 1;
a primary transfer device having a primary transfer member that primarily transfers a toner image formed on a surface of an image holder onto the outer peripheral surface of the intermediate transfer belt; and
a secondary transfer device having a secondary transfer member that is arranged in contact with the outer peripheral surface of the intermediate transfer belt and that secondarily transfers the toner image transferred onto the outer peripheral surface of the intermediate transfer belt onto a surface of a recording medium.

18. A transfer device comprising:
an intermediate transfer belt having an outer peripheral surface onto which a toner image is transferred, the intermediate transfer belt including the endless belt according to claim 2;
a primary transfer device having a primary transfer member that primarily transfers a toner image formed on a surface of an image holder onto the outer peripheral surface of the intermediate transfer belt; and
a secondary transfer device having a secondary transfer member that is arranged in contact with the outer peripheral surface of the intermediate transfer belt and that secondarily transfers the toner image transferred onto the outer peripheral surface of the intermediate transfer belt onto a surface of a recording medium.

19. A transfer device comprising:
an intermediate transfer belt having an outer peripheral surface onto which a toner image is transferred, the intermediate transfer belt including the endless belt according to claim 3;
a primary transfer device having a primary transfer member that primarily transfers a toner image formed on a surface of an image holder onto the outer peripheral surface of the intermediate transfer belt; and
a secondary transfer device having a secondary transfer member that is arranged in contact with the outer peripheral surface of the intermediate transfer belt and that secondarily transfers the toner image transferred onto the outer peripheral surface of the intermediate transfer belt onto a surface of a recording medium.

20. An image forming apparatus comprising:
a toner image forming device that has an image holder and that forms a toner image on a surface of the image holder; and
the transfer device according to claim 17, which transfers the toner image formed on the surface of the image holder onto a surface of a recording medium.
